(19) United States
(12) Patent Application Publication
(10) Pub. No.: US 2002/0093158 A1
(43) Pub. Date: Jul. 18, 2002

(54) Juvenile stroller with portable cooler

(76) Inventors: Dennis M. Turner, Mooresville, IN (US); Andrew Mendenhall, Indianapolis, IN (US); Paul T. Zink, Anderson, IN (US)

Correspondence Address: BARNES & THORNBURG, 11 SOUTH MERIDIAN, INDIANAPOLIS, IN, 46204

(21) Appl. No.: 10/044,126

(22) Filed: Jan. 11, 2002

Related U.S. Application Data
(60) Provisional application No. 60/261,605, filed on Jan. 12, 2001.

(51) Int. Cl. B62B 9/00

(52) U.S. Cl. 280/47.35; 280/47.38

(57) ABSTRACT

A juvenile stroller includes a stroller frame and a cooler configured to store items in a cooled environment. The cooler is attachable to and detachable from a basket support frame included in the stroller frame. In one embodiment, the cooler hangs behind a storage basket coupled to the basket support frame. In other embodiments, the cooler is located in a cavity provided in the storage basket.

This application claims priority under 35 U.S.C. 119(e) to U.S. Provisional Application Serial No. 60/261,605, filed Jan. 12, 2001, which is expressly incorporated by reference herein.

### BACKGROUND AND SUMMARY

The present disclosure relates to juvenile strollers, and particularly to stroller accessories. More particularly, the present disclosure relates to storage units adapted to be carried onboard a juvenile stroller.

Juvenile strollers are being adapted to carry various child-care items in handy onboard locations in addition to carrying infants or other young children. Caregivers appreciate the convenience of being able to store child-care items or other items needed by caregivers or siblings onboard the stroller so that those items will be available to the caregiver when the stroller is being used to transport a child away from home or vehicle.

According to the present disclosure, a juvenile stroller includes a stroller frame and a thermally insulated cooler configured to store items in a temperature-controlled environment. The cooler is coupled to the stroller frame to move therewith. Attachment means is provided for temporarily coupling the cooler to the stroller frame so that the cooler is attached to the stroller frame to move therewith and is detachable from the stroller frame at the option of a user.

In one embodiment, the cooler includes a cooler body and a belt coupled to the cooler body. The attachment means includes a pair of connector posts fixed to the stroller frame and a connector coupled to each end of a belt included in the cooler and arranged to be coupled to one of the connector posts to link the cooler to the stroller frame. In other embodiments, the cooler is placed in a cavity formed in a container coupled to the stroller frame and the attachment means includes a retainer coupled to the cooler and configured to mate with a portion (e.g. side wall or partition) of the container upon placement of the cooler in the cavity.

Additional features of the disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a portable cooler in accordance with a first embodiment of this disclosure adapted to be mounted on a stroller frame to move therewith, the cooler including a cooler body, a belt coupled to the cooler body, and a pair of connectors coupled to the belt and adapted to mate with connector posts mounted on the stroller frame (as suggested in FIGS. 2 and 3) to retain the cooler in a fixed position relative to the stroller frame;

FIG. 2 is a perspective view of the cooler of FIG. 1 mounted on a juvenile stroller and showing a seat frame, a storage basket positioned to lie below a seat coupled to the seat frame, a basket support frame, and the cooler coupled to a rear section of the basket support frame to lie alongside a rear wall of the storage basket;

FIG. 3 is a sectional view taken along line 3-3 of FIG. 2 showing mating engagement of one of the connectors with a companion connector post mounted on a rear section of the basket support frame and showing a portion of the belt extending from the connector to the cooler body and lying above an upwardly facing curved portion of the rear section of the basket support frame;

FIG. 4 is a perspective view of a portable cooler in accordance with another embodiment of the disclosure before it is mounted in a cooler storage cavity formed in a rear portion of a container coupled to a seat frame and arranged to lie under a seat coupled to the seat frame;

FIG. 5 is a perspective view similar to FIG. 4 after the cooler has been placed in the cooler storage cavity and clipped to a partition section of the basket support frame to move with the stroller;

FIG. 6 is a perspective view of a portable cooler in accordance with another embodiment of the disclosure before it is mounted in a cooler storage cavity formed in a rear portion of a container coupled to a seat frame and arranged to lie under a seat coupled to the seat frame; and

FIG. 7 is a perspective view similar to FIG. 6 after the cooler has been placed in the cooler storage cavity and clipped to a side section of the basket support frame to move with the stroller.

### DETAILED DESCRIPTION OF THE DRAWINGS

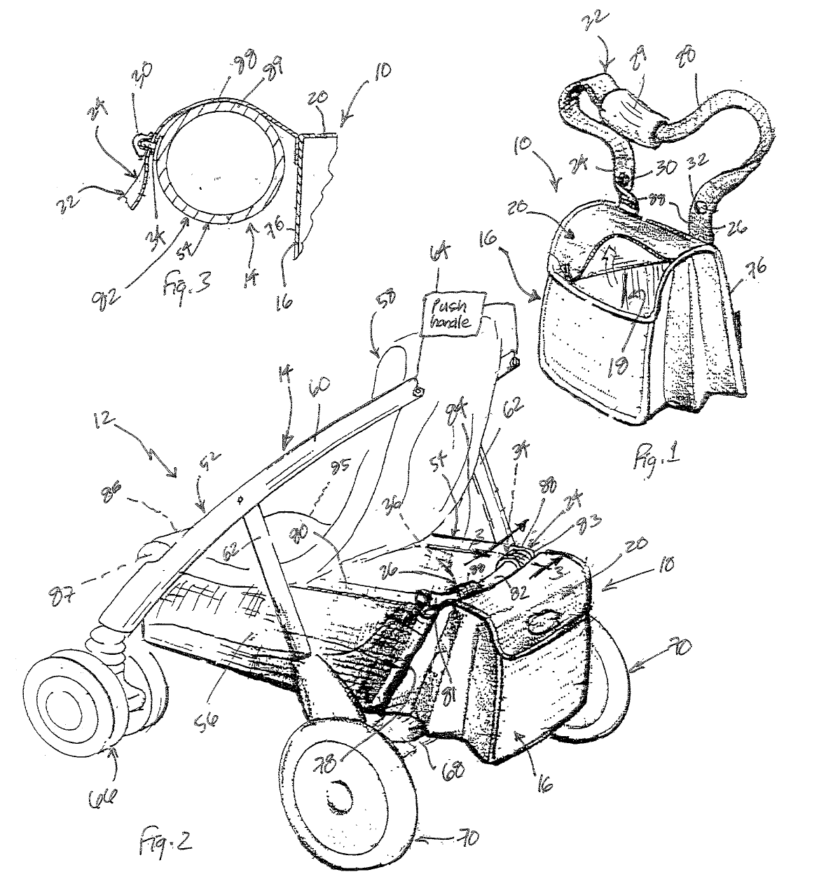

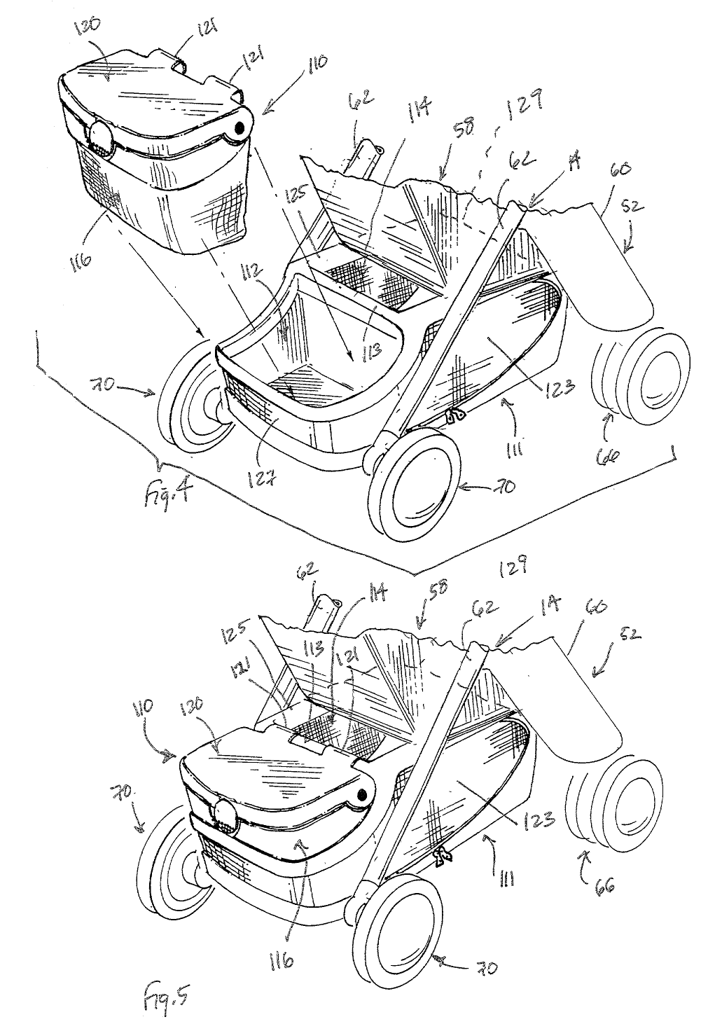

A thermally insulated portable cooler 10 configured to store items in a cooled environment is shown in FIG. 1. A juvenile stroller 12 includes a stroller frame 14 and cooler 10 as shown, for example, in FIG. 2. The cooler 10 is coupled to the stroller frame 14 as shown, for example, in FIGS. 2 and 3 to move therewith as the stroller 12 is pushed by a caregiver.

Cooler 10 includes a cooler body 16 formed to include an interior cold storage region 18 therein and a cooler lid 20. Cooler lid 20 is coupled to cooler body 16 for movement between a closed position (shown in FIGS. 1 and 2) covering an opening into interior cold storage region 18 and an opened position (not shown) uncovering the opening into interior cold storage region 18.

Cooler body 16 and lid 20 cooperate to provide a thermally insulated case in which caregivers can store child-care or other items to be maintained in a cooled environment. This thermally insulated case is adapted to receive an ice pack or any other suitable low-temperature source to lower the temperature in interior cold storage region 18 to a selected temperature target or range. Such a thermally insulated case is also adapted to receive a heat pack or any other suitable high-temperature source. Cooler 10 functions as a thermally insulated storage region to maintain products stored therein at a desired temperature relative to an ambient temperature outside the storage region for a desired period of time so that cold products stored in the thermally insulated storage region will be maintained at their cold temperature and warm products stored in the thermally insulated storage region will be maintained at their warm temperature.

Cooler 10 also includes a belt 22 coupled to cooler body 16 as shown, for example, in FIGS. 1 and 3 to provide a cooler handle. This cooler handle facilitates transport of cooler body 16 by a user once cooler body 16 is separated from stroller frame 14. It is within the scope of this disclosure to couple belt 22 to lid 20 of cooler 10 or to any other suitable portion of cooler 10.

A first end portion 24 of belt 22 is coupled to one portion of cooler body 16 (as suggested in FIGS. 1-3) while a second end portion 26 of belt 22 is coupled to another portion of cooler body 16. A carrying strap 28 interconnects first and second end portions 24, 26 as shown, for example in FIG. 1. A hand grip 29 is provided on carrying strap 28.

First and second connectors 30, 32 are carried on belt 22 and used to mount cooler body 16 on stroller frame 14 to move therewith. First connector 30 is coupled to first end portion 24 of belt 22 and second end connector 32 is coupled to second end portion 26 of belt 22 as shown, for example, in FIG. 1. Each connector 30, 32 is located on belt 22 to lie in spaced-apart relation to cooler body 16.

First and second connector posts 34, 36 are mounted on a portion of stroller frame 14 as suggested in FIGS. 2 and 3. First connector 30 is configured to mate with first connector post 34 and second connector 32 is configured to mate with second connector post 36 to retain cooler body 16 in a fixed position on stroller frame 14. Belt 22, first and second connectors 30, 32, and the mating first and second connector posts 34, 36 cooperate, for example, to provide attachment means for temporarily coupling cooler body 16 to stroller frame 14 so that cooler 10 is attached to stroller frame 14 to move therewith and is detachable from stroller frame 14 at the option of a user. In the illustrated embodiment, first connector 30 and first connector post 34 cooperate to form a “snap-together” connection. It is within the scope of this disclosure to use other suitable connection systems including, for example, buttons in button holes, ties, hook-and-loop fasteners, or clasps on clasp mounts.

Stroller frame 14 includes a seat frame 52, a basket support frame 54 coupled to seat frame 52, and a storage basket 56 coupled to basket support frame 54. A seat 58 is coupled to seat frame 52 in any suitable manner. It is within the scope of this disclosure to employ a wide variety of seats and seat frames. In the illustrated embodiment, seat frame 52 includes a pair of front legs 60, a pair of rear legs 62, and a push handle 64. A set of front wheels 66 is coupled to each front leg 60 as shown, for example, in FIG. 2 and a rear axle 68 carrying a rear wheel 70 at each end is coupled to rear legs 62 as shown, for example, in FIG. 2.

Basket support frame 54 is made of a tubular member that is bent to form, in series, straight left section 80, left rear corner portion 81, straight rear section 82, right rear corner portion 83, straight right section 84, a front right corner portion 85, a straight front section 86, and a front left corner portion 87. Basket support frame 54 carries one or more connector posts 34, 36 as shown, for example in FIG. 3. Each connector post 34, 36 is located and configured to couple to one of connectors 30, 32 so that cooler 10 is coupled to stroller frame 14 to move therewith as a user pushes stroller 12 to transport a child. Each connector post 34, 36 is coupled to the straight rear section 82 included in basket support frame 54 so that a rear wall 76 of cooler body 16 will lie alongside a rear wall 78 of storage basket 56 when cooler 10 is coupled to stroller frame 14 to move therewith. It is within the scope of this disclosure to locate connector posts 34, 36 in other suitable locations on basket support frame 54 or other portions of stroller frame 14 or seat 58 to enable cooler 10 to move with stroller frame 14.

Storage basket 56 can be coupled to basket support frame 54 in any suitable manner. It is within the scope of this disclosure to form basket support frame 54 and storage basket 56 as a single unit if desired. Basket support frame 54 and storage basket 56 cooperate to form a container, which container can be mounted in any suitable location on stroller frame 14. In the illustrated embodiment, basket support frame 54 is coupled to seat frame 52 to cause a front portion of storage basket 56 to lie under seat 58 and a rear wall 78 of storage basket 56 to lie generally above rear axle 68.

Mating engagement of first connector 30 on belt 22 with a companion first connector post 32 mounted on rear section 82 of basket support frame 54 is shown in FIG. 3. A portion 88 of belt 22 extending from connector 30 to cooler body 16 lies above an upwardly facing curved portion 89 of rear section 82 of basket support frame 54.

When cooler 10 is mounted on rear section 82 of basket support frame 54, carrying strap 28 hangs downwardly and lies in a cavity formed in storage basket 56 as shown, for example, in FIG. 2. To remove cooler 10 from its mounted position on basket support frame 54, it is necessary only to grasp carrying handle 28 or cooler body 16 and move cooler 10 relative to basket support frame 54 to uncouple first connector 30 from first connector post 34 and uncouple second connector 32 from second connector post 36.

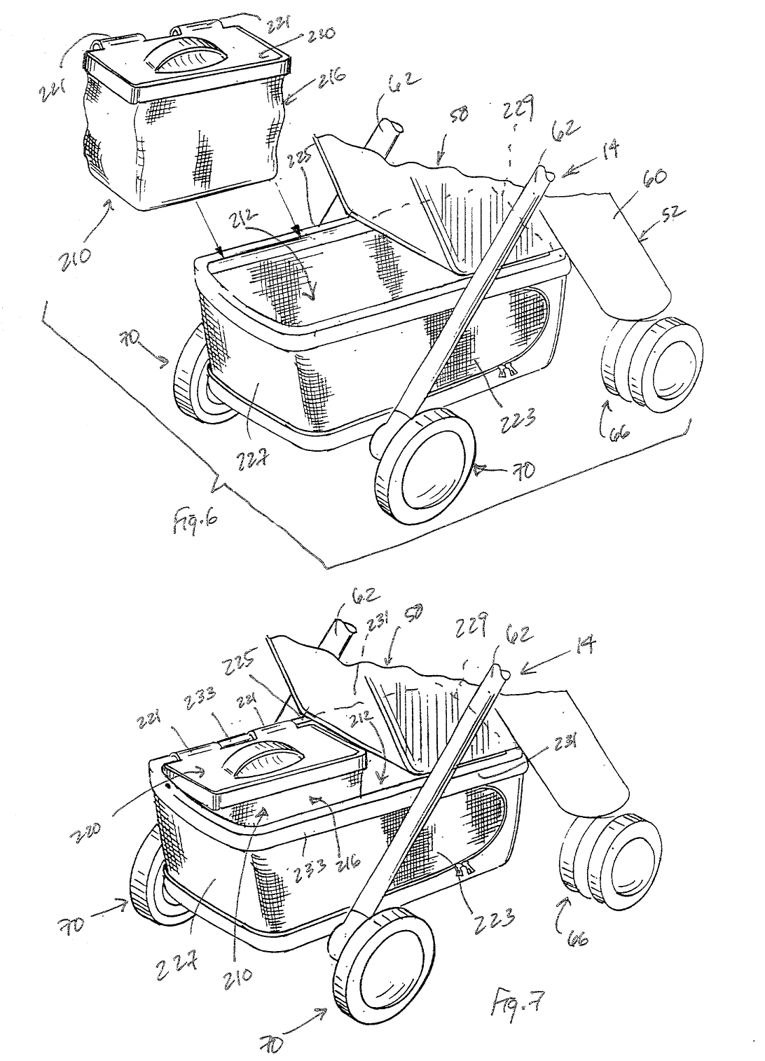

In another embodiment, a portable thermally insulated cooler 110 is adapted to be located in a rear cavity 112 formed in a container 111 coupled to stroller frame 14 as suggested in FIGS. 4 and 5. Cooler 110 includes a cooler body 116 and a lid 120 mounted for opening and closing movement relative to cooler body 116.

Retainers 121 are configured to mate with container 111 upon placement of cooler body 116 in rear cavity 112 in container 111. In the illustrated embodiment, each retainer 121 is a clip or hook and is coupled to a rear edge of lid 120 for movement therewith.

As shown, for example, in FIG. 4, container 111 includes a pair of spaced-apart side walls 123, 125, and a front end wall 129 coupled to a front end of each of side walls 123, 125. Container 111 further includes a partition 113 coupled to a mid-section of each of the spaced-apart side walls.

Rear cavity 112 is located between rear end wall 127, partition 113, and rear portions of side walls 123, 125 while a front cavity 114 is located between partition 113, front end wall 129, and front portions of side walls 123, 125. When cooler body 116 is placed into rear cavity 112, the retainers 121 included in cooler 10 mate with a top edge of partition 113. It is within the scope of this disclosure to provide a wide variety of transverse structures including, for example, bars, rods, screens that lie at or between side walls 123, 125 to provide means for engaging any retainer 121 included in cooler 10 to assist in retaining cooler 10 in rear cavity 112 of container 111.

In yet another embodiment, a portable thermally insulated cooler 210 is adapted to be located in a cavity 212 formed in a container 211 coupled to stroller frame 14 as suggested in FIGS. 6 and 7. Cooler 210 includes cooler body 216 and a lid 220 mounted for opening and closing movement relative to cooler body 216. Retainers 221 are configured to mate with container 211 upon placement of cooler body 216 in cavity 212 in container 211. In the illustrated embodiment, each retainer 221 is a clip or hook and is coupled to a rear edge of lid 220 for movement therewith.

As shown, for example, in FIG. 6, container 211 includes a pair of spaced-apart side walls 223, 225, a rear end wall 227 coupled to a rear end of each side wall 223, 225, and a front end wall 229 coupled to a front end of each of side walls 223, 225. Each of side walls 223, 225 includes a forward section 231 arranged to lie under seat 58 to define a forward portion of cavity 212 therebetween and a rearward section 233 arranged to lie between rear wheels 70 to define a rearward portion of cavity 212 therebetween. As shown, for example, in FIG. 7, cooler 210 is located in the rearward portion of cavity 212 and retainers 221 are coupled to rearward section 233 of side walls 225. It is within the scope of this disclosure to couple retainers 221 to any of sections 233 or to rear end wall 227 or other suitable portion of container 223.

1. A juvenile stroller comprising
a stroller frame,
a thermally insulated cooler configured to store items in a cooled environment, and
attachment means for temporarily coupling the cooler to the stroller frame so that the cooler is attached to the stroller frame to move therewith and is detachable from the stroller frame at the option of a user.

2. The juvenile stroller of claim 1, wherein the cooler includes a cooler body and a belt coupled to the cooler body and the attachment means includes a connector post mounted on the stroller frame and a connector carried on the belt and configured to mate with the connector post to retain the cooler body in a fixed position relative to the stroller frame.

3. The juvenile stroller of claim 2, wherein the stroller frame includes a seat frame, a basket support frame, and a storage basket coupled to the basket support frame, and the connector post is mounted on the basket support frame.

4. The juvenile stroller of claim 3, wherein the basket support frame includes an inner surface facing toward an interior region of the storage basket, an outer surface facing away from the interior region of the storage basket, and an upwardly facing surface lying between the inner and outer surfaces, the connector post is mounted on the inner surface, and the belt extends over the upwardly facing surface to retain an upper portion of the cooler body adjacent to the outer surface.

5. The juvenile stroller of claim 3, wherein the belt has a first end portion coupled to one portion of the cooler body and a second end portion coupled to another portion of the cooler body, and a carrying strap interconnecting the end portions, the connector is located on the first end portion to lie in spaced-apart relation to the cooler body, and the attachment means further includes a second connector post mounted on the basket support frame and a second connector located on the second end portion to lie in spaced-apart relation to the cooler body and configured to mate with the second connector post to retain the cooler body in the fixed position to the stroller frame.

6. The juvenile stroller of claim 2, wherein the stroller includes a seat frame and a storage container coupled to the seat frame and the connector post is mounted on the storage container.

7. The juvenile stroller of claim 2, wherein the belt has a first end portion coupled to one portion of the cooler body and a second end portion coupled to another portion of the cooler body, and a carrying strap interconnecting the end portions, the connector is located on the first end portion to lie in spaced-apart relation to the cooler body, and the attachment means further includes a second connector post mounted on the container and a second connector located on the second end portion to lie in spaced-apart relation to the cooler body and configured to mate with the second connector post to retain the cooler body in the fixed position to the stroller frame.

8. The juvenile stroller of claim 1, wherein the attachment means includes a first connector post mounted on the stroller frame and a first connector carried on the cooler and configured to mate with the first connector post to retain the cooler in a fixed position relative to the stroller frame.

9. The juvenile stroller of claim 8, wherein the attachment means further includes a second connector post mounted on the stroller frame to lie in spaced-apart relation to the first connector post and a second connector carried on the cooler and configured to mate with the second connector post to retain the cooler in the fixed position relative to the stroller frame.

10. The juvenile stroller of claim 9, wherein the stroller frame includes a seat frame, a basket support frame, and a storage basket coupled to the basket support frame and the first and second connector posts are mounted on the basket support frame.

11. The juvenile stroller of claim 1, wherein the stroller frame includes a seat frame and a container coupled to the seat frame and formed to include front and rear cavities separated by a partition, and the cooler is located in the rear cavity.

12. The juvenile stroller of claim 11, wherein the cooler includes a cooler body located in the rear cavity and formed to include an interior cold storage region and a lid mounted for movement relative to the cooler body between a closed position covering an opening into the interior cold storage region and an opened position uncovering the opening into the interior cold storage region, and the attachment means includes a retainer coupled to the lid to move therewith and configured to mate with the partition upon placement of the cooler body in the rear cavity of the container.

13. The juvenile stroller of claim 12, wherein the stroller frame includes a pair of rear legs and a rear wheel axle coupled to the rear legs and arranged to extend between the rear legs and the container is coupled to the seat frame to position the rear cavity and the cooler body located therein above the rear wheel axle.

14. The juvenile stroller of claim 1, wherein the stroller includes a seat frame and a container coupled to the seat frame and formed to include front and rear end walls and a pair of side walls lying in spaced-apart relation to one another and extending between the front and rear end walls to define a cavity and the cooler is located in the cavity and coupled to one of the side walls.

15. The juvenile stroller of claim 14, wherein the cooler includes a cooler body located in the cavity, and formed to include an interior cold storage region and a lid mounted for movement relative to the cooler body between a closed position covering an opening into the interior cold storage region and an opened position uncovering the opening into the interior cold storage region, and the attachment means includes a retainer coupled to the lid to move therewith and configured to mate with said one of the side walls upon placement of the cooler body in the cavity of the container.

16. A juvenile stroller comprising
a stroller frame,
first and second connector posts mounted on the stroller frame,
a container coupled to the stroller frame,
a portable thermally insulated cooler coupled to the container to move therewith, and
first and second connectors carried on the cooler, each of the first and second connectors being configured to mate with one of the first and second connector posts to retain the cooler in a fixed position relative to the stroller frame.

17. The juvenile stroller of claim 16, wherein the container includes a basket support frame and a storage basket coupled to the basket support frame and the first and second connector posts are mounted on the basket support frame.

18. The juvenile stroller of claim 17, wherein the stroller frame includes a pair of rear legs and a rear wheel axle coupled to the rear legs and arranged to extend between the rear legs, the basket support frame includes a rear section positioned to lie above the real wheel axle, and the first and second connector posts are mounted on the rear section of the basket support frame.

19. The juvenile stroller of claim 17, wherein the cooler includes a cooler body and a belt coupled to the cooler body and the first and second connectors are carried on the belt.

20. A juvenile stroller comprising
a stroller frame including front legs, front wheels coupled to the front legs, rear legs, rear wheels mounted for rotation about an axis relative to the rear legs, and a push handle arranged to extend above the rear wheels,
a seat coupled to the stroller frame to move therewith,
a container coupled to the stroller frame and arranged to lie under the seat, the container including a basket support frame coupled to the stroller frame and a storage basket coupled to the basket support frame, the storage basket including a pair of spaced-apart side walls and a rear wall, each side wall being arranged to extend along a length of the stroller frame between one of the front wheels and one of the rear wheels, the rear wall being arranged to extend between rear ends of the side walls and lie in a space between the rear wheels,
a first connector post mounted on the basket support frame and located along the rear wall of the storage basket, and
a portable thermally insulated cooler including a cooler body, a belt coupled to the cooler body, and a first connector coupled to the belt and coupled to the first connector post mounted on the basket support frame to cause the cooler body to lie alongside the rear wall of the storage basket and below the push handle.

21. A juvenile stroller comprising
a stroller frame including front legs, front wheels coupled to the front legs, rear legs, rear wheels mounted for rotation about an axis relative to the rear legs, and a push handle arranged to extend above the rear wheels,
a seat coupled to the stroller frame to move therewith,
a container coupled to the stroller frame and arranged to lie under the seat, the container being formed to include a cavity, and
a portable thermally insulated cooler located in the cavity formed in the container and coupled to the container to move therewith.

22. A juvenile stroller of claim 21, wherein the container includes a pair of spaced-apart side walls, a rear end wall coupled to a rear end of each of the spaced-apart side walls, and a partition coupled to a mid-section of each of the spaced-apart side walls to locate the cavity between the rear end wall and the partition, and the container is coupled to the partition.

23. The juvenile stroller of claim 22, wherein the container further includes a front end wall coupled to a front end of each of the spaced-apart side walls to define a second cavity between the front end wall and the partition.

24. The juvenile stroller of claim 22, wherein the container is positioned relative to the seat frame to cause the cavity and the cooler located therein to lie in a space between the rear wheels.

25. The juvenile stroller of claim 22, wherein the cooler includes a cooler body located in the cavity and formed to include an interior cold storage region, a lid mounted for movement relative to the cooler body between a closed position covering an opening into the interior cold storage region and an opened position uncovering the opening into the interior cold storage region, and a retainer coupled to the lid to move therewith and configured to mate with the partition upon placement of the cooler body in the cavity of the container.

26. The juvenile stroller of claim 21, wherein the container includes a pair of spaced-apart side walls arranged to locate the cavity therebetween and the cooler is coupled to one of the side walls.

27. The juvenile stroller of claim 26, wherein the side walls include forward sections arranged to lie under the seat to define a forward portion of the cavity therebetween and rearward sections arranged to lie between the rear wheels to define a rearward portion of the cavity therebetween and the cooler is located in the rearward portion of the cavity and coupled to one of the rearward sections of the side walls.

28. The juvenile stroller of claim 26, wherein the cooler includes a cooler body located in the cavity and formed to include an interior cold storage region, a lid mounted for movement relative to the cooler body between a closed position covering an opening into the interior cold storage region and an opened position uncovering the opening into the interior cold storage region, and a retainer coupled to the lid to move therewith and configured to mate with one of the side walls upon placement of the cooler body in the cavity of the container.
